(19) United States
(12) Patent Application Publication
(10) Pub. No.: US 2016/0248082 A1
(43) Pub. Date: Aug. 25, 2016

(54) All-Solid-State Cathode Materials, Cathodes, Batteries And Methods

(71) Applicant: THE REGENTS OF THE UNIVERSITY OF COLORADO, A BODY CORPORATE, Denver, CO (US)

(72) Inventors: Thomas A. YERSAK, San Diego, CA (US); Tyler EVANS, Boulder, CO (US); Se-Hee LEE, Louisville, CO (US); Justin Michael WHITELEY, Boulder, CO (US)

(21) Appl. No.: 15/026,195

(22) PCT Filed: Sep. 30, 2014
(86) PCT No.: PCT/US14/58428

§ 371 Date: Mar. 30, 2016

Related U.S. Application Data
(60) Provisional application No. 61/884,747, filed on Sep. 30, 2013.

(51) Int. Cl. H01M 4/36; H01M 4/136; H01M 10/0525; H01M 4/58; H01M 10/0562

(52) U.S. Cl. CPC H01M 4/364; H01M 4/5815; H01M 10/0562; H01M 10/0525; H01M 4/136; H01M 2004/028

(57) ABSTRACT

Described herein are various embodiments of methods of making an all-solid-state electrode material for a rechargeable battery comprising in a first mixing step, mixing one of a transition metal phosphide, a transition metal oxide, and a transition metal sulfide with sulfur to produce a first mixture, in a first heat-treating step, heating the first mixture to a temperature ranging between about 250 degrees C. and about 450 degrees C. to produce a heat-treated second mixture comprising an active material and a glass former/electrolyte precursor, in a second mixing step, mixing the second mixture with a glass/electrolyte modifier to produce a third mixture, and permitting the third mixture to react to produce the cathode material, the cathode material comprising the active material and a solid state electrolyte. Electrode materials, electrodes, and batteries made using the foregoing and similar methods are also described.

### CROSS-REFERENCE TO RELATED APPLICATIONS

This application claims benefit of priority to U.S. provisional application Ser. No. 61/884,747, filed Sep. 30, 2013, entitled “All-Solid-State Cathode Materials, Cathodes, Batteries and Methods,” which is incorporated herein by reference.

### GOVERNMENT RIGHTS

This invention was made with government support under grant number FA8650-08-1-7839 awarded by the Air Force Research Laboratory. The government has certain rights in the invention.

### FIELD

Various embodiments described herein relate to the field of primary and secondary electrochemical cells, electrodes and electrode materials, and corresponding methods of making and using same.

### BACKGROUND

The Li₂S—P₂S₅ system of glass-ceramic lithium ion conductors is a well-established system that has been around since the early 1980's. In this system the glass former is P₂S₅ while the glass modifier is Li₂S. Additionally, dopants such as LiI or GeS₂ may be added to increase the glass electrolyte's ionic conductivity or increase its stability window, respectively. U.S. Pat. No. 4,513,070 entitled “Vitreous materials with ionic conductivity, the preparation of same and the electrochemical applications thereof′ and included herein by reference, filed in 1983 covered a wide range of glass electrolyte compositions, yet commercially available bulk-type all-solid-state batteries are still not available. More recently, as described in work by Hassoun et al. in 2013 and Kamaya et al. in 2011, the ceramic, Li₁₀GeP₂S₁₂, demonstrated an ionic conductivity of 10⁻² S cm⁻¹ at room temperature comparable to organic liquid electrolytes. Regardless of this long research history, spanning over three decades, and the availability of suitable electrolytes, a practical bulk-type all-solid-state battery (“SSB”) remains absent.

### SUMMARY

In an embodiment, a method of making an all-solid-state electrode material for a rechargeable battery includes the following steps: (1) mixing one of a transition metal phosphide, a transition metal oxide, and a transition metal sulfide with sulfur to produce a first mixture, (2) in a first heat-treating step, heating the first mixture to a temperature ranging between 250 degrees C. and 450 degrees C. to produce a heat-treated second mixture including an active material and a glass former/electrolyte precursor, (3) mixing the second mixture with a glass/electrolyte modifier to produce a third mixture, and (4) reacting the third mixture to produce the electrode material, the electrode material including the active material and a solid state electrolyte.

In another embodiment, an all-solid-state composite electrode material includes (1) a first active material including at least one of a transition metal sulfide, lithium sulfide, and elemental sulfur, (2) a solid-state electrolyte, and (3) a second active material including titanium sulfide.

In yet another embodiment, an all-solid-state composite electrode material includes (1) an active material including at least one of a transition metal sulfide, lithium sulfide, and elemental sulfur, and (2) a solid-state electrolyte and titanium sulfide.

Further embodiments are disclosed herein or will become apparent to those skilled in the art after having read and understood the specification and drawings hereof.

### BRIEF DESCRIPTION OF DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1 is a schematic view of an active material and electrolyte interface in a liquid electrolyte battery (a) vs. an all-solid-state battery (b), in accordance with an embodiment.

FIG. 2 is a bar chart of the specific energy of an all-solid-state Fe₂P derived FeS₂ cathode compared to other state-of-the-art electrodes in either solid-state or liquid electrolyte configurations, in accordance with an embodiment.

FIG. 3 is a plot of the x-ray diffraction (“XRD”) analyses of a 2Fe₂P+9S composite prior to heat treatment, a 2Fe₂P+9S composite after heat treatment at 300° C., and a 22.5(2Fe₂P+9S):77.5Li₂S electrode composite, in accordance with an embodiment.

FIG. 4 is a plot of the XRD analyses of a 2Fe₂P+13S composite prior to heat treatment, a 2Fe₂P+13S composite after heat treatment at 350° C., and a 22.5(2Fe₂P+13S):77.5Li₂S electrode composite, in accordance with an embodiment.

FIG. 5 is a plot of the first 10 discharge-charge cycles of a 22.5(2Fe₂P+9S):77.5Li₂S electrode at 60° C., in accordance with an embodiment.

FIG. 6 is a plot of the first 4 discharge-charge cycles of a 22.5(2Fe₂P+13S):77.5Li₂S electrode at 60° C., in accordance with an embodiment.

FIG. 7 is a plot of the results of a rate test of a 22.5(2Fe₂P+9S):77.5Li₂S electrode at 60° C., in accordance with an embodiment.

FIG. 8 is a plot of voltage profiles associated with a rate test of a 22.5(2Fe₂P+9S):77.5Li₂S electrode at 60° C. in accordance with an embodiment.

FIG. 9 is a Ragone plot for a 22.5(2Fe₂P+9S):77.5Li₂S electrode at 60° C., in accordance with an embodiment.

FIG. 10 is a composite plot of a rate study of LiTiS₂ electrodes at 30° C. (subplots a and b) and 60° C. (subplots c and d), in accordance with an embodiment.

FIG. 11 is a plot of electrode rate tests for specific cathode formulations containing either a carbon black or LiTiS₂ conductive additive, in accordance with an embodiment.

FIG. 12 is a Ragone plot for specific cathode formulations containing either a carbon black or LiTiS₂ conductive additive, in accordance with an embodiment.

FIG. 13 is a flow chart for a process of making an all-solid-state cathode material for a rechargeable battery, in accordance with an embodiment.

### DETAILED DESCRIPTION OF ILLUSTRATED EMBODIMENTS

In the following description, specific details are provided to impart a thorough understanding of the various embodiments of the invention. Upon having read and understood the specification, claims and drawings hereof, however, those skilled in the art will understand that some embodiments of the invention may be practiced without hewing to some of the specific details set forth herein. Moreover, to avoid obscuring the invention, some well-known methods, processes, devices, and systems finding application in the various embodiments described herein are not disclosed in detail.

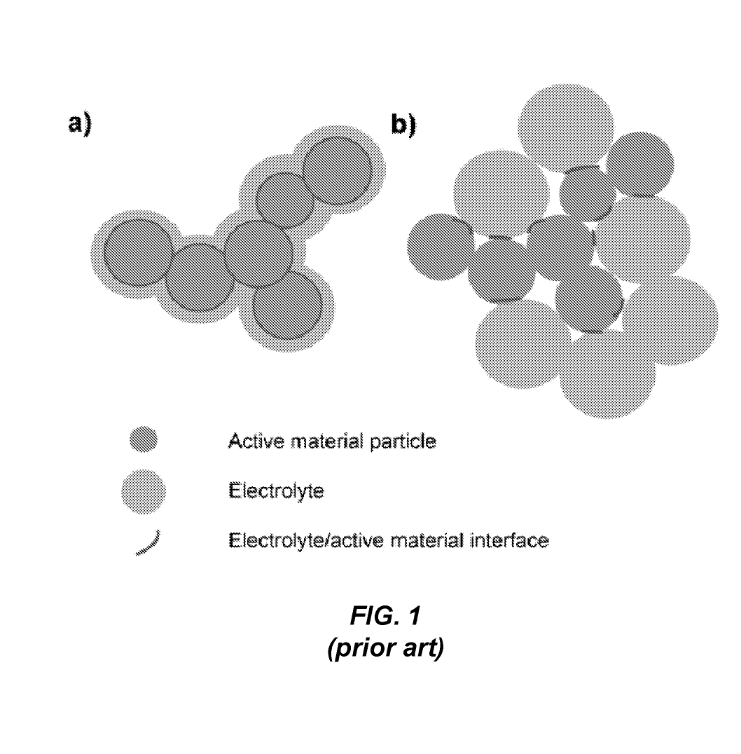

In regard to the absence of the availability of a practical bulk-type all-solid-state battery, one answer to this question is rooted in the difficulty it takes to structure intimate solid-solid interfaces in composite electrodes. As an example, FIG. 1 is a visualization of the difference between an electrolyte to active material interface in a conventional liquid electrolyte battery and that in an all-solid-state battery. In a liquid electrolyte battery, (FIG. 1.a), the wettability of the electrolyte and the porosity of the electrode dictate the quality of the electrolyte to active material interface. The interfacial impedance of a conventional liquid electrolyte battery is naturally low because the liquid electrolyte can intimately interface with the active material to form a liquid-solid junction. In an all-solid-state battery, (FIG. 1.b), interfacial impedance is much higher because the junction is limited to the small contact area between solid-state electrolyte (“SSE”) particles and the active material particles. In order to increase the contact area in solid-state composite electrodes, a large weight percentage of SSE is often included in the composite cathode. In return for providing acceptable power and active material utilization, the incorporation of these passive components greatly reduces the volumetric and gravimetric energy density of solid-state batteries.

The poor solid-solid interface problem is exacerbated when one considers that some SSEs are not stable versus LiCoO₂ and other high voltage cathode materials. Thin coatings on LiCoO₂ can largely solve this problem by passivating the interface, but the choice of LiCoO₂ as the cathode material does not align with the strengths of an all-solid-state battery. In order to use the all-solid-state architecture to its full potential, intercalation-type active materials which dominate the commercial liquid battery space should be exchanged for high-capacity conversion-type active materials. An all-solid-state architecture is uniquely suited for secondary conversion chemistries because the SSE provides excellent electro-active species confinement for good reversibility. Inventors' previous research, see for example, “Solid State Enabled Reversible Four Electron Storage,” Yersak, et al., Advanced Energy Materials 3, 120-127 (2013), results demonstrate the reversibility of FeS₂ with four electrons involved as a cathode at 60° C.

Electrode engineering largely approaches the problem of interfacial structuring from the perspective that the individual electrode components must be synthesized ex-situ prior to electrode fabrication. To demonstrate the limitations of this perspective, inventors' previous all-solid-state FeS₂ battery research may again be considered. In that research, solvo-thermally synthesized μm-sized FeS₂ particles, mechano-chemically prepared Li₂S—P₂S₅ solid-state electrolyte, and carbon black were mechanically mixed in a weight ratio of 10:20:2, respectively. Each component of this electrode was prepared ex-situ prior to the fabrication of the complete electrode. Unfortunately, the FeS₂ mass loading of the all-solid-state composite cathode of this research was limited to 32%. Even though FeS₂ has a theoretical capacity of 894 mAh g⁻¹, the cathode could only achieve an overall capacity of 280 mAh g⁻¹ (based on the whole composite electrode) because the passive electrode components diminished achievable specific capacity.

Many studies have approached interfacial engineering from the perspective that electrode components must be prepared ex-situ. Because inventors' previous FeS₂ electrode was cold pressed, its densification would be a straightforward way to improve the interfacial contact between the Li₂S—P₂S₅ glass electrolyte and FeS₂ active material. Along these lines, Kituara et al. in J. Mater. Chem. 21 (2010) (1) 118, introduced hot isostatic pressing as a way to improve the interface between Li₂S—P₂S₅ and their LiCoO₂ and Li₄Ti₅O₁₂ active materials. In this method, the glass electrolyte is heated past its glass transition temperature to close void spaces in the electrode. Similarly, spark plasma sintering has been suggested as an appropriate sintering method for all-solid-state electrodes based on the Li_{1.5}Al_{0.5}Ge_{1.5}(PO₄)₃ ceramic electrolyte. Unfortunately, both of these methods limit the choice of acceptable active materials. The LiCoO₂ electrode produced by hot isostatic pressing failed to work because of a chemical instability between LiCoO₂ and Li₂S—P₂S₅ at 210° C. and spark plasma sintering requires electronically shorting the cell. Additionally, pulsed laser deposition of Li₂S—P₂S₅ glass electrolyte coatings onto active material particles has also been suggested as a way to improve interfacial contact.

On the other hand, interfacial engineering can be approached from the perspective that the electrode components should be prepared in-situ. In several studies, for example, Kanamura et al. in Journal of Power Sources 146 (2005) (1-2) 86, have impregnated macro-porous glass-ceramic electrolyte structures with the sol-gel precursors to LiMn₂O₄, Li₄Mn₅O₁₂, and Li₄Ti₅O₁₂. The macro-porous glass-ceramic electrolyte was prepared ex-situ while the active material was prepared in-situ. These electrodes are more appropriate for 3D thin film batteries given the complicated process involved in preparing the macro-porous electrolyte structures.

As an object of the present invention, the concept of in-situ preparation is advanced one step further and both the active material and glass-ceramic electrolyte are prepared in-situ. The improved methods provide an all-solid-state electrode with a specific energy (Wh kg⁻¹ with respect to the total electrode mass) that is among the highest ever reported, for either liquid electrolyte batteries or all-solid-state batteries. The various embodiments described herein below result in cathode materials and cathodes having improved contact area or solid-solid interface between the active material and the solid state electrolyte, and are made possible in one illustrative embodiment by synthesizing a glass electrolyte precursor (e.g., P₂S₅) and an active material (e.g., FeS₂) in-situ.

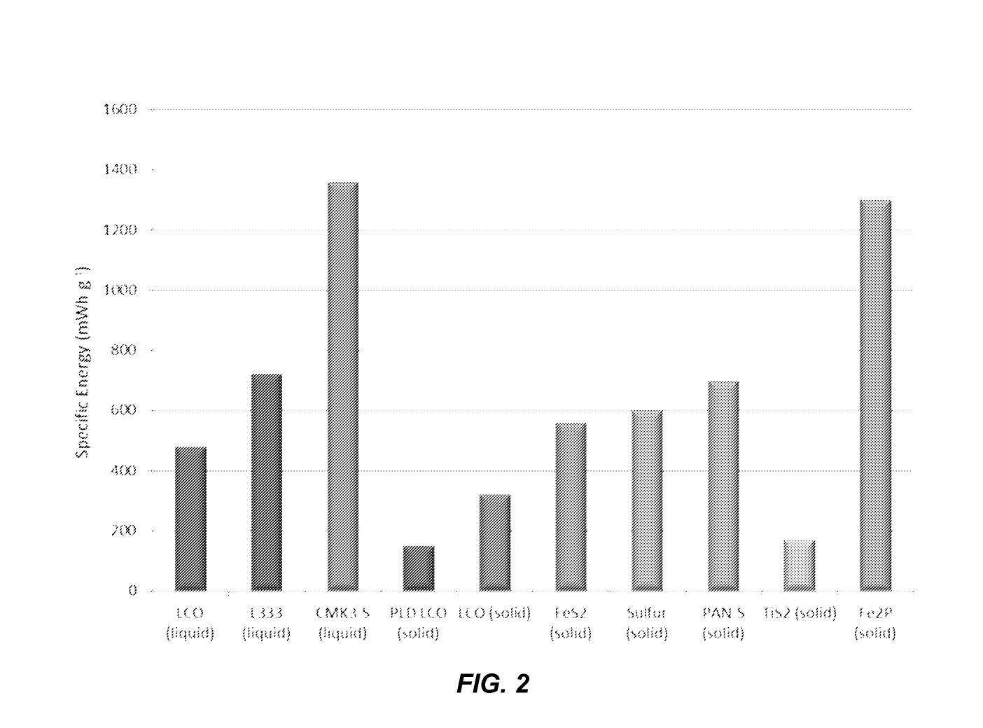

FIG. 2 shows the specific energy of an all-solid-state Fe₂P derived FeS₂ cathode of the current invention compared to other state-of-the-art solid-state and liquid electrolyte cells. Specific energy was chosen rather than specific capacity in order to make comparisons between high capacity conversion materials and traditional high voltage metal oxides more relevant. Specific energy calculations were made by assuming that the anode was lithium metal for each cathode. In liquid electrolyte cells specific energy is given with respect to the total mass of the active material, binder and conductive additive. For all-solid-state cells, specific energy is given with respect to active material, solid-state electrolyte and conductive additive. Because the porous cathodes in liquid electrolyte cells do not consider the mass of the impregnated liquid electrolyte, a comparison with all-solid-state electrodes is not quite balanced.

As an example of the methods, materials and performance improvements provided by the current invention, the example of Fe₂P derived FeS₂ electrodes will be described in detail. In order to structure an intimate solid-solid interface in the composite electrode, the active material (FeS₂) is synthesized in-situ. Neither Fe₂P nor sulfur is considered to be an ionic conductor and sulfur is a conversion active material with a theoretical capacity of 1672 mAh g⁻¹. Relatedly, sulfur and its fully reduced form with lithium, Li₂S, are both highly ionically and electronically resistive. Furthermore, Fe₂P is not electrochemically active but is electronically conductive.

To form the electrode, Fe₂P and sulfur are mechano-chemically combined in a stoichiometric ratio. Two products, iron sulfide (FeS) or iron pyrite (FeS₂) may result from the reaction between Fe₂P and sulfur. For this reason, two stoichiometric ratios of Fe₂P to sulfur may be studied. A first ratio of 2:9, represented by Equation 1 below, expects FeS as a reaction product. A second ratio of 2:13, represented by Equation 2 below, expects FeS₂ as a reaction product. After mechanical mixing, the Fe₂P and sulfur composite is heat treated at a temperature between 300-350° C. and other ranges of heating temperatures are possible. After in-situ preparation of the active material (FeS or FeS₂), the next step of the process is to mechano-chemically add the glass modifier (Li₂S) to give the electrode composite its ionic conductivity. After the addition of Li₂S, the final expected compositions of the 2:9 and 2:13 ratio electrodes are given by Equations 3 and 4, respectively.

2Fe₂P+9S→4FeS+P₂S₅ Eqn. 1

2Fe₂P+13S→4FeS₂+P₂S₅ Eqn. 2

22.5(4FeS+P₂S₅)+77.5Li₂S→90FeS+22.5P₂S₅:77.5Li₂S Eqn. 3

22.5(4FeS₂+P₂S₅)+77.5Li₂S→90FeS₂+22.5P₂S₅:77.5Li₂S Eqn. 4

To contrast the above electrode forming method with the standing convention for composite electrode preparation, the example of the FeS₂ all-solid-state battery may be reconsidered. In this example, the first step is to prepare the 77.5Li₂S:22.5P₂S₅ glass electrolyte by mechano-chemically combining the Li₂S and P₂S₅ precursors. The second step involves mechanically mixing the prepared glass electrolyte with FeS₂. Mixing pre-made FeS₂ and glass electrolyte particles does not result in new reaction products and results in inferior interparticle contact so that more glass electrolyte is needed to fully utilize the FeS₂.

Further specific details of the above example are as follows. A first mechano-chemically combining step via ball milling combines 2 g total of Fe₂P (available from Aldrich, 99.5%) and sulfur (available from Aldrich 99.98%) in the desired molar ratio in a 500 mL stainless steel jar (available from Across International) with two 16 mm diameter and twenty 10 mm diameter stainless steel balls (available from Across International) for 20 hours at 500 rpm.

The mechanically combined composite is then heat treated in a flame sealed borosilicate glass ampoule at 300-350° C. and other ranges of heating temperatures may be considered. The heat treatment follows this protocol: i) The sample is ramped to the target treatment temperature over one hour. ii) The sample dwells at the target for 3 hours. iii) The sample is then permitted to ramp back down to room temperature over the course of several hours.

A second ball mill step involves adding the desired amount of Li₂S or dopant (e.g. GeS₂ or LiI) to the heat treated composite. In this specific example, 0.5 g total of material is added to a 100 mL agate jar (available from Across International) with fifty 6 mm diameter and five 10 mm diameter agate balls for 20 hours at 500 rpm. Optionally, a second heat treatment at a variety of temperatures can be performed and follows the same procedure outlined above. If heat treatment temperatures in excess of 400° C. are used, a quartz ampoule is used instead of a borosilicate ampoule. The final electrode was synthesized by adding carbon powder (carbon black) (available from TimCal, C65) to the composite electrode powder in a 3:30 weight ratio, respectively, via mechanical mixing with an agate mortar and pestle.

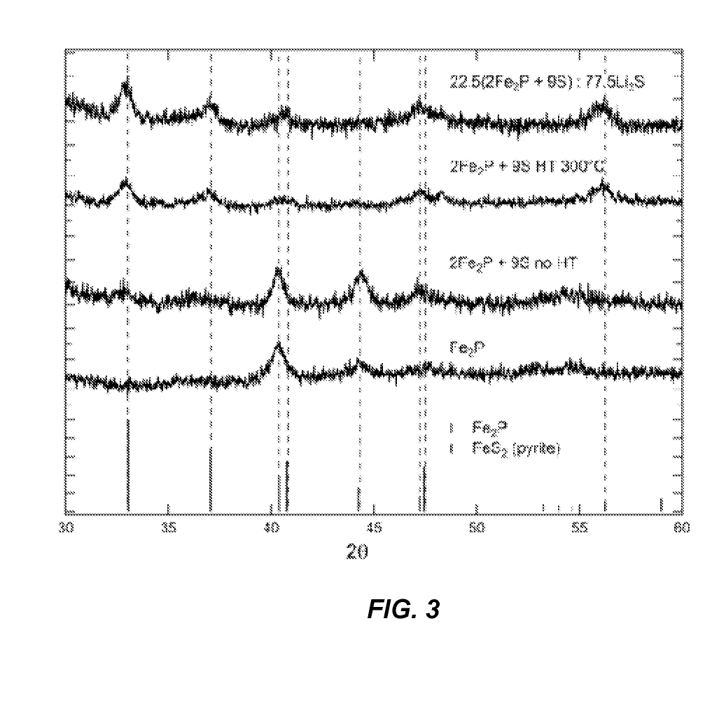

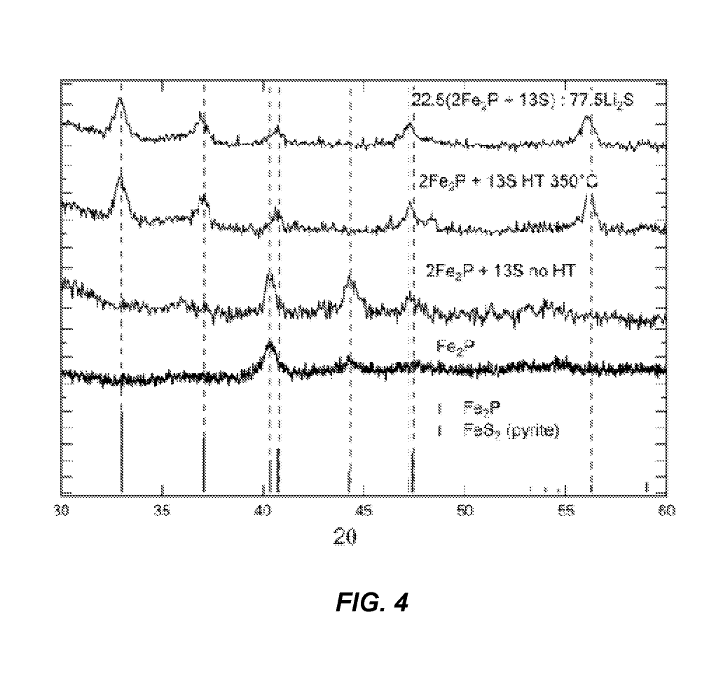

Identification of the possible reaction products for the Fe₂P and sulfur may be performed by analysis of x-ray diffraction (“XRD”) data collected from the prepared electrode materials. FIG. 3 is a plot of multiple traces of the XRD analyses for a 2Fe₂P+9S composite. The traces are from bottom to top: 1) Fe₂P only, 2) a 2Fe₂P+9S composite prior to heat treatment, 3) a 2Fe₂P+9S composite after heat treatment at 300° C., and 4) a resultant 22.5(2Fe₂P+9S):77.5Li₂S electrode composite. FIG. 4 is a plot of multiple traces of the XRD analyses for a 2Fe₂P+13S composite. The traces are from bottom to top: 1) Fe₂P only, 2) a 2Fe₂P+13S composite prior to heat treatment, 3) a 2Fe₂P+13S composite after heat treatment at 350° C., 4) and a resultant 22.5(2Fe₂P+13S):77.5Li₂S electrode composite.

From analysis of the XRD plots it may be concluded that FeS₂ is the product of the reaction of Fe₂P and S and not FeS. This discovery is important because it means that electrodes with higher energy density can be synthesized by this method. It is also evident from the XRD plots that heat treatment changes the composite and additional experimentation and analysis indicates that heat treatment is required to initiate the reaction. Prior to heat treatment, only Fe₂P peaks are observed. It should be noted that related literature presents only one other study by Mizuno et al. in Solid State Ionics 177 (2006) (26-32) 2753, where a Li₂S—P₂S₅ electrolyte was synthesized with precursors that do not include P₂S₅. It should be specifically noted that this work describes only a resulting electrolyte and not an electrolyte-cathode composite.

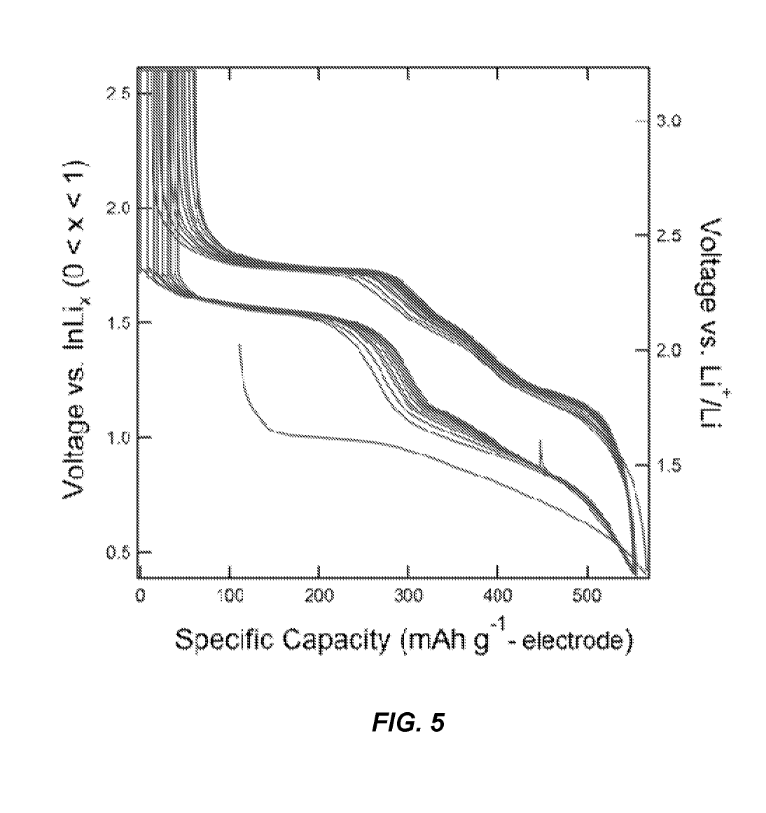

In the following plots it should be noted that all specific capacities are given with respect to the total composite electrode mass and not just active material. FIG. 5 is a plot of the first 10 discharge-charge cycles of a 22.5(2Fe₂P+9S):77.5Li₂S electrode at 60° C. For this 2:9 ratio electrode, the initial charge is larger than the initial discharge by 110 mAh g⁻¹ and the excess capacity can be attributed to the electrochemical utilization of excess Li₂S. On its second discharge the 2:9 ratio electrode provides a specific discharge of 550 mAh g⁻¹ and a specific energy of nearly 1.0 Wh g⁻¹. Because FeS₂ is a product of the reaction between Fe₂P and sulfur and not FeS, the 2:9 ratio electrode is sulfur deficient.

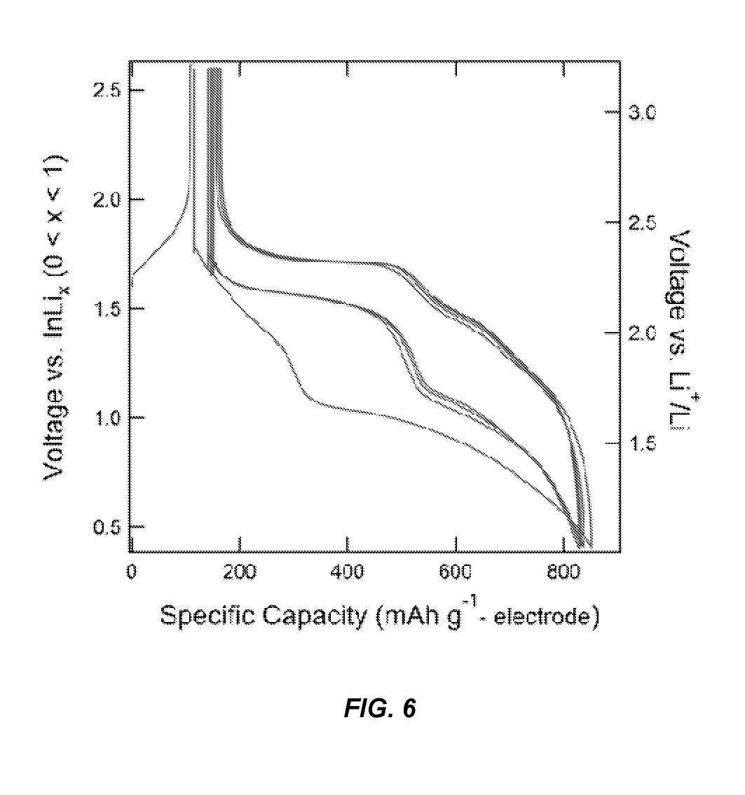

As expected and shown in FIG. 6, the 2:13 electrode delivers an even higher specific capacity of 700 mAh g⁻¹ on its initial discharge. FIG. 6 is a plot of the first 4 discharge-charge cycles of a 22.5(2Fe₂P+13S):77.5Li₂S electrode at 60° C. The cell is initially overcharged and excess capacity is again attributed to utilization of excess Li₂S. In anticipation of the Li₂S utilization, this cell was initially overcharged to provide an extra 100 mAh g⁻¹ of capacity. Assuming a complete reaction of Fe₂P and sulfur via Equation 2, the electrode should only deliver a specific capacity of 600 mAh g⁻¹ when the utilization of excess Li₂S is also considered. The extra 100 mAh g⁻¹ suggests that the reaction of Fe₂P and sulfur did not progress to completion and that excess sulfur is available for direct reduction.

Related testing has shown that thicker electrodes have delivered an equivalent specific capacity. This observation rules out the possibility that the extra capacity originated from the glass electrolyte separator. On its second discharge, the 2:13 ratio electrode delivers a specific energy of 1.3 Wh g⁻¹. This specific energy, nearly doubling the previous state-of-the-art for all-solid-state electrodes, is equivalent to the energy delivered by carbon-sulfur liquid electrolyte cell systems, and has none of the problems associated with polysulfide dissolution.

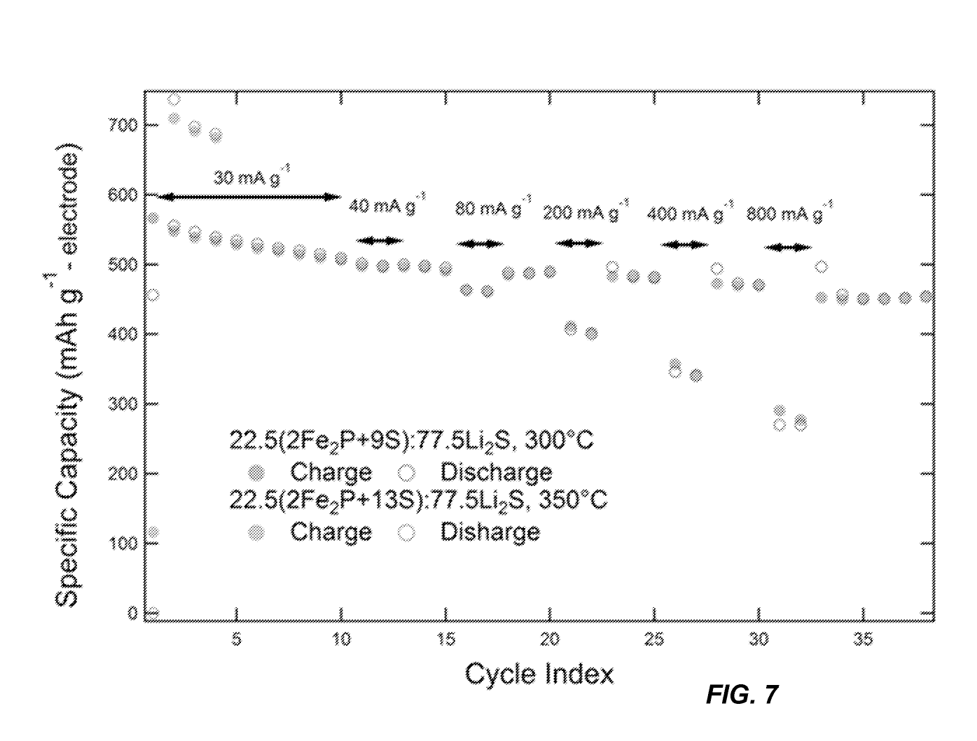

FIGS. 7, 8 and 9 present the data associated with the 2:9 electrode's rate test. FIG. 7 shows the results of a 22.5(2Fe₂P+9S):77.5Li₂S electrode's rate test at 60° C. The electrode maintains a specific capacity of over 300 mAh g⁻¹ at a current density of 800 mA g⁻¹ corresponding to a C-rate of 1.6 C. The first 4 cycles of the 22.5(2Fe₂P+13S):77.5Li₂S electrode at 60° C. are also provided for comparison. A 1 C rate is the rate that would correspond to a 1 hour charge or discharge. Relatedly, a C/5 rate corresponds to 5 hour (lower current) charge or discharge, and a 2 C rate corresponds to a charge or discharge in ½ hour (higher current).

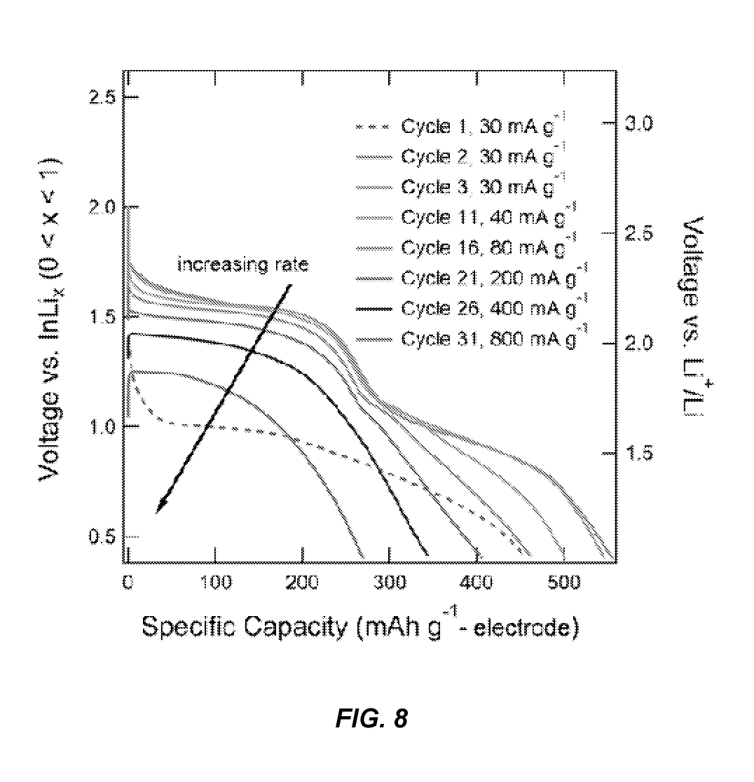

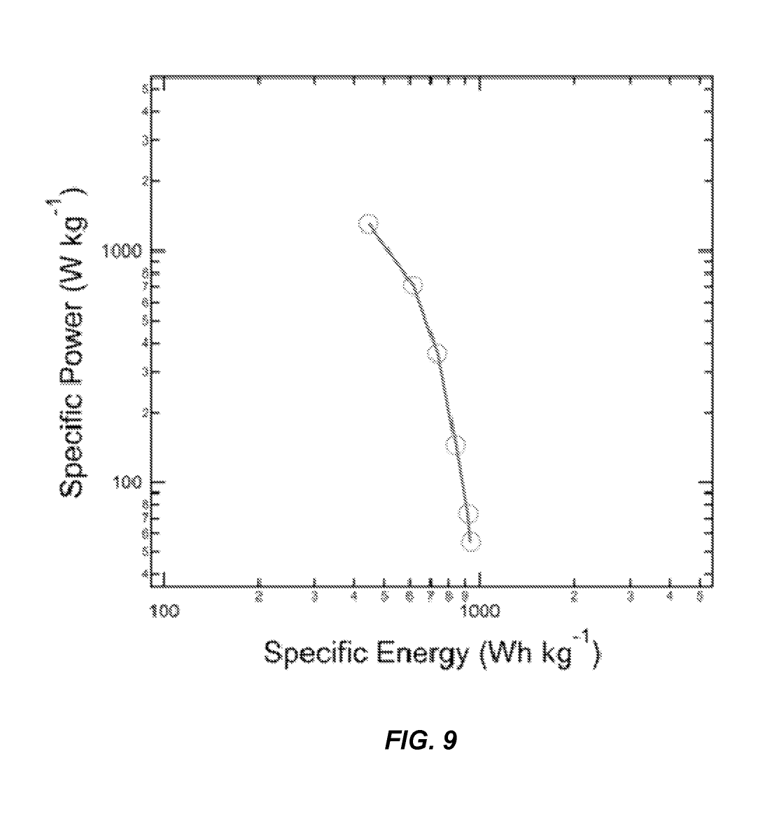

FIG. 8 shows voltage profiles associated with a 22.5(2Fe₂P+9S):77.5Li₂S electrode's rate test at 60° C. The reaction associated with the lower voltage plateau is kinetically limited at faster rates. The second plateau is associated with the reaction of phases like Li₂FeS₂ and FeS to form FeO and Li₂S. It is theorized that the kinetics of this reaction may be kinetically limited for two reasons. Firstly, extra energy is required to nucleate the new phases of FeO and Li₂S. Secondly, the solid-state diffusion of Fe atoms is slow. FIG. 9 shows a Ragone plot for a 22.5(2Fe₂P+9S):77.5Li₂S electrode at 60° C. The electrode provides a maximum specific power of 1.32 W g⁻¹.

The testing of examples of the improved electrodes has demonstrated that the Fe₂P derived FeS₂ all-solid-state electrodes have ionic conductivities on the order of 10⁴ S cm⁻¹ at room temperature, but higher values are desired in order to demonstrate better electrode performance at higher rates and lower temperatures. A higher overall electrode ionic conductivity is also needed to make thick solid-state electrodes practical. There are multiple methods and changes that may be incorporated to increase ionic conductivity and overall performance.

The addition of dopants to the Li₂S—P₂S₅ glass electrolyte system may improve the ionic conductivity of the glass by an order of magnitude. For example, an appropriate amount, such as from 0-50 mol % with 0-25% being most common, of LiI or other dopant can be added with Li₂S during the second ball milling to improve the ionic conductivity of the glass electrolyte. With the inclusion of the dopant, a second heat treatment may be optional or unnecessary.

In another example, GeS₂ may be added with Li₂S during the second ball milling step to permit precipitation of the Li₁₀GeP₂S₁₂ lithium super-ionic conductor. A secondary heat treatment at 500-550° C. will then be performed to precipitate the super-ionically conducting ceramic phase. FeS₂ having been reported to be stable at temperatures up to 550° C. and previous inventors' work cyclizing PAN-FeS₂ composites showed little evidence of natural FeS₂ degradation at 500° C. This suggests that the in-situ synthesized FeS₂ will be stable at the high heat treatment temperatures needed to precipitate the Li₁₀GeP₂S₁₂.

In the Fe₂P derived electrode material the active material, FeS₂, is intimately interfaced with the in-situ prepared Li₂S—P₂S₅ electrolyte. However, ionic transport through the in-situ prepared Li₂S—P₂S₅ electrolyte may not be sufficient for high power. In a further example, the addition of conventionally (ex-situ) prepared Li₂S—P₂S₅ electrolyte powder with the Fe₂P derived FeS₂ cathode powder may provide higher power operation. This composite can be prepared via vortex or mechanical mixing. The intention of this method is to engineer an electrode with a hierarchical structure for faster ionic transport through the bulk of the electrode. The conventionally (ex-situ) prepared Li₂S—P₂S₅ electrolyte provides fast ionic conduction into the bulk of the electrode at which point the in-situ prepared Li₂S—P₂S₅ electrolyte then distributes lithium ions to the FeS₂ active material. In this way, a thick electrode with acceptable energy density and power may be formed.

In a further example, to increase the power and energy density of the Fe₂P derived cathodes, the carbon powder can be replaced with TiS₂ and/or LiTiS₂. LiTiS₂ fulfills the same role of carbon powder because it is electronically and ionically conductive, but LiTiS₂ is also electrochemically active which improves capacity over carbon or metal conductive additives. By replacing carbon powder with TiS₂ and/or LiTiS₂ the specific energy of the overall electrode may be increased by eliminating passive electrode components. TiS₂ and/or LiTiS₂ may also have a higher tap density than conductive carbon powders which improves cathode manufacturability and volumetric energy density. Furthermore, the layered TiS₂ and/or LiTiS₂ material has a lower hardness than FeS₂, so it conforms to FeS₂ surfaces during cathode compaction resulting in lower interfacial resistance. Blending active materials incorporates the strengths of each active material into one electrode. Specifically, blending in-situ prepared FeS₂ for energy and (Li)TiS₂ for power. The TiS₂ and/or LiTiS₂ additives are also uniquely suited to the FeS₂ cathode construction in the solid-state. Firstly, FeS₂ is a hard material which limits the interparticle and interlayer contact. Secondly, the softer TiS₂ and/or LiTiS₂ provides more surface area in contact between the hard FeS₂ particles. In liquid electrolyte systems, these well-suited properties are not critical since the liquid electrolyte can conform easily to active particle surfaces. It should be noted that blending active materials is a well-established and common practice for liquid electrolyte systems.

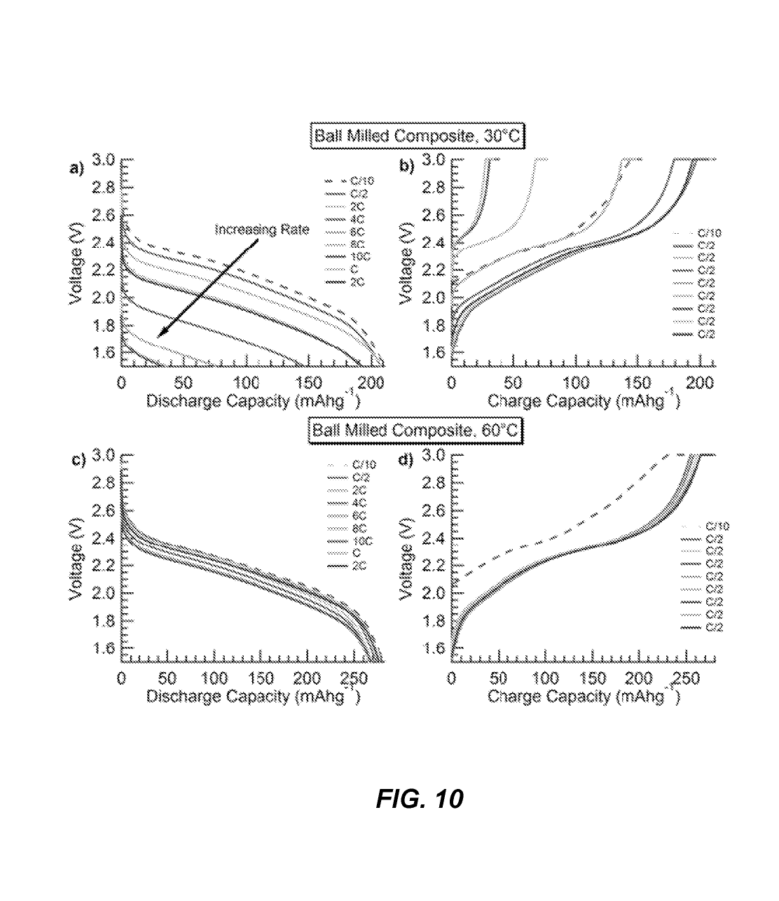

FIG. 10 shows rate data of LiTiS₂ at 30° C. (a and b) and 60° C. (c and d). The cells were discharged at C-rates between C/2 and 10 C based upon LiTiS₂'s theoretical capacity of 226 mAh g⁻¹. The charge rate was kept constant at C/2 for all cycles. At an operating temperature of 60° C. and a discharge rate of 10 C the LiTiS₂ solid-state electrode suffers an over-potential of only 0.2V while maintaining nearly 90% of its C/2 capacity.

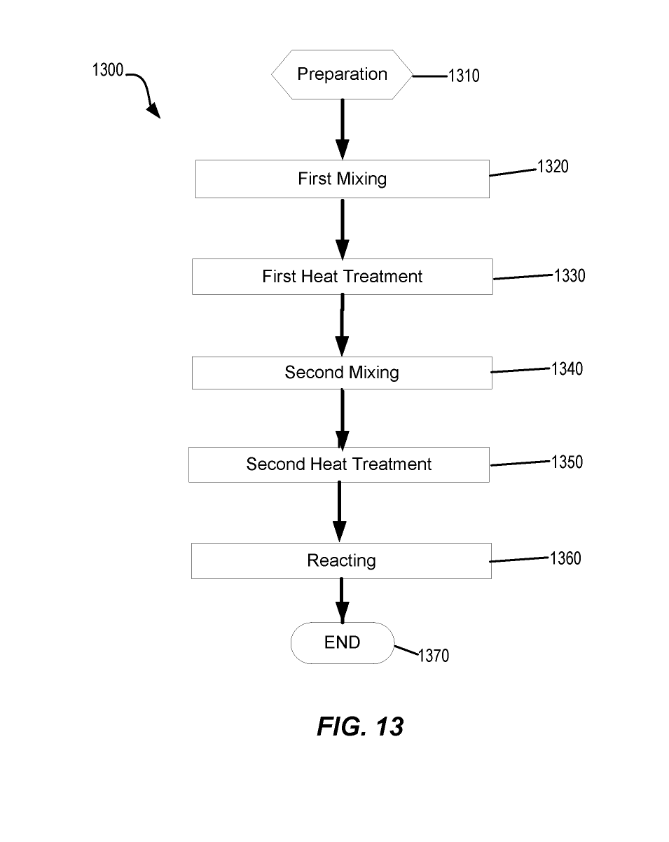

The inclusion of TiS₂ and/or LiTiS₂ follows the same process as described above and additionally in accordance with FIG. 13, defined herein below, but replacing the carbon powder with TiS₂ and/or LiTiS₂. Li₃N and TiS₂ are used as starting materials to produce the LiTiS₂. LiTiS₂ equivalent is prepared by mechanically milling a stoichiometric mixture of Li₃N and TiS₂. The mixture has a TiS₂ to Li₃N weight ratio of 9.6 which corresponds to LiTiS₂ assuming complete decomposition of Li₃N. In one example, 250 mg of the TiS₂ and Li₃N mixture was ball milled in a 100 mL agate vial at 500 rpm for 2 hours.

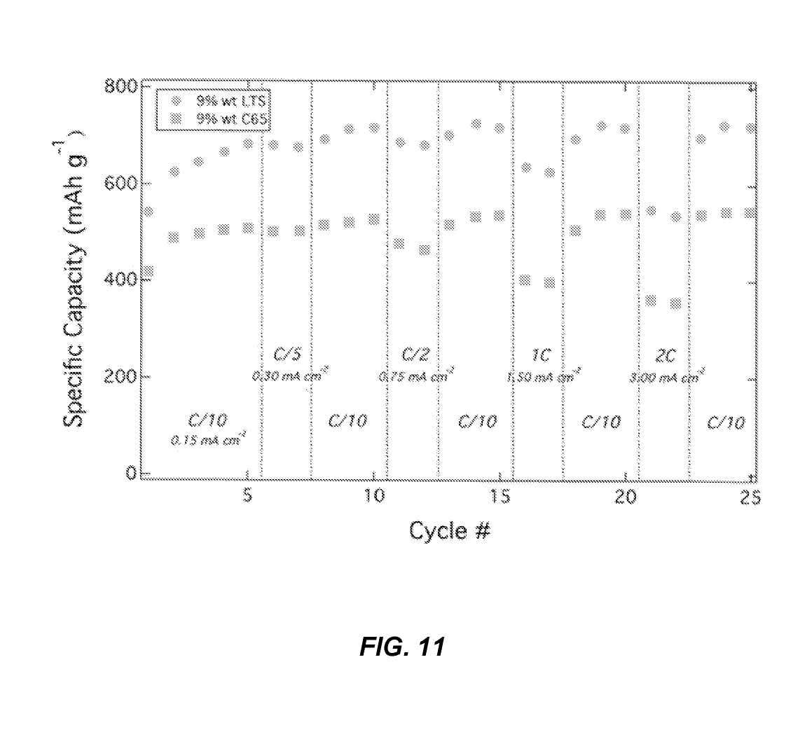

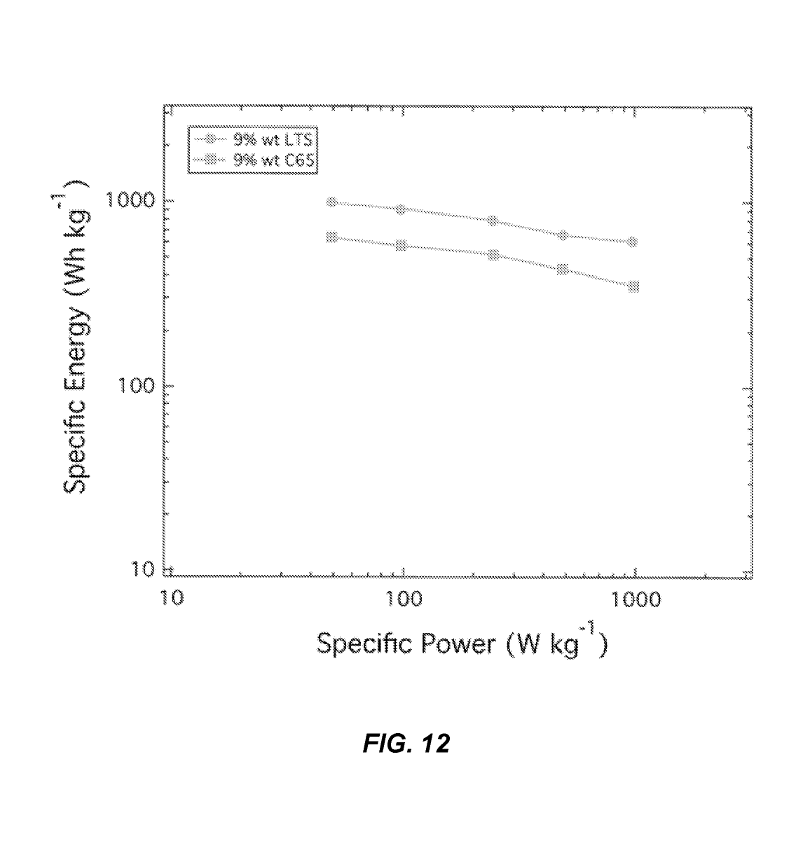

FIG. 11 shows a plot of the comparative rate study of FeS₂ cathodes with 9% by weight LiTiS₂ and C65 carbon powder. The cells are discharged at progressively higher rates, and either the cathode specific capacity is plotted vs C-rate or the cathode specific energy is plotted vs. specific power. FIG. 12 shows a Ragone plot of the comparative performance of the same cathodes. The forgoing FIGS. 11 and 12 indicate that the LiTiS₂ additive provides both higher energy and higher power than the standard carbon additive.

FIG. 13 is a flow chart detailing the steps of a process 1300 of making an all-solid-state cathode material and battery, as described by the methods herein above. Process 1300 initiates with a preparation step 1310 wherein any necessary or optional setup and preparation steps may be performed. Setup and preparation operations may include, for example, the proper selection of precursor materials and heat treatment temperature. Once any preparatory operations are completed, process 1300 advances to step 1320 wherein a first mixing of material is performed. As described herein above a first mixing step may include mixing one of a transition metal phosphide, a transition metal oxide, and a transition metal sulfide with sulfur to produce a first mixture. Next in step 1330, the mixture from step 1320 may be heat treated to a temperature ranging between about 250 degrees Celsius and about 450 degrees Celsius to produce a heat-treated second mixture comprising an active material and a glass former/electrolyte precursor. Following heat treatment, process 1300 advances to step 1340 wherein a second mixing operation is performed and the second mixture is mixed with a glass/electrolyte modifier to produce a third mixture. Next, is step 1350, a second heat treatment may be performed such as to increase conductivity of the material being processed. In step 1360, the third mixture may react or be reacted to produce the cathode material, the cathode material including the active material and a solid state electrolyte. In a final step 1370 process 1300 ends and any further actions may be performed. Further actions may include association of the formed composite electrode material with a separator and anode, packaging to define a cell and evaluation of the system. Any and all steps of process 1300 may be duplicated, re-ordered and/or modified to suit the specific needs to the exact materials undergoing processing.

It should thus be noted that the matter contained in the above description or shown in the accompanying drawings should be interpreted as illustrative and not in a limiting sense. The above-described embodiments should be considered as examples of the present invention, rather than as limiting the scope of the various inventions. In addition to the foregoing embodiments of inventions, review of the detailed description and accompanying drawings will show that there are other embodiments of such inventions. Accordingly, many combinations, permutations, variations and modifications of the foregoing embodiments of inventions not set forth explicitly herein will nevertheless fall within the scope of such inventions. The following claims are intended to cover all generic and specific features described herein, as well as all statements of the scope of the present method and system, which, as a matter of language, might be said to fall there between.

What is claimed is:

1. A method of making an all-solid-state electrode material for a rechargeable battery, comprising:
mixing one of a transition metal phosphide, a transition metal oxide, and a transition metal sulfide with sulfur to produce a first mixture;
in a first heat-treating step, heating the first mixture to a temperature ranging between 250 degrees Celsius and 450 degrees Celsius to produce a heat-treated second mixture comprising an active material and a glass former/electrolyte precursor;
mixing the second mixture with a glass/electrolyte modifier to produce a third mixture, and
reacting the third mixture to produce the electrode material, the electrode material comprising the active material and a solid state electrolyte.

2. The method of claim 1, wherein the transition metal phosphide is iron phosphide.

3. The method of claim 1, wherein the active material comprises at least one of iron pyrite; a phase of iron sulfide comprising at least one of FeS₂, FeS and Fe₇S₈; MoS; MoS₂; MoS₃; MoO; NiS; NiS₂; NiS₃; NiO; FeO; and V₂S₅.

4. The method of claim 1, wherein the temperature of the first heat-treating step ranges between 300 degrees C. and 400 degrees C.

5. The method of claim 1, wherein the temperature of the first heat-treating step ranges between 325 degrees C. and 375 degrees C.

6. The method of claim 1, wherein the glass former/electrolyte precursor comprises at least one of phosphorus sulfide; P₂S₅, P₂O₅, and P₄Sₓ, where x≦10; iodine; chlorine; bromine; and lithium sulfide.

7. The method of claim 1, further comprising adding a dopant to the second mixture.

8. The method of 7, wherein the dopant comprises at least one of germanium disulfide, lithium iodide, titanium sulfide and lithium titanium sulfide.

9. The method of claim 1, wherein the solid state electrolyte is a glass-ceramic lithium conductor.

10. The method of claim 9, wherein the glass-ceramic lithium conductor comprises Li₁₀GeP₂S₁₂.

11. The method of claim 1, further comprising adding carbon powder to the third mixture.

12. The method of claim 1, further comprising a second heat-treating step to increase the conductivity of the solid state electrolyte.

13. The method of claim 1, the step of mixing one of a transition metal phosphide, a transition metal oxide, and a transition metal sulfide with sulfur comprising mixing Fe₂P with S, where a ratio of Fe₂P to S is 2 to 9.

14. The method of claim 1, the step of mixing one of a transition metal phosphide, a transition metal oxide, and a transition metal sulfide with sulfur comprising mixing Fe₂P with S, where a ratio of Fe₂P to S is 2 to 13.

15. An all-solid-state composite electrode material, comprising:
a first active material comprising at least one of a transition metal sulfide, lithium sulfide, and elemental sulfur;
a solid-state electrolyte; and
a second active material comprising titanium sulfide.

16. The electrode material of claim 15, wherein the transition metal sulfide comprises a phase of iron sulfide comprising at least one of FeS₂, FeS and Fe₇S₈.

17. The electrode material of claim 15, wherein the titanium sulfide includes particles having a diameter of less than 2 microns.

18. The electrode material of claim 15, wherein the titanium sulfide is lithiated.

19. The electrode material of claim 18, wherein the lithiated titanium sulfide is formed in-situ.

20. The electrode material of claim 15, containing about 2 to 40% titanium sulfide by mass.

21. The electrode material of claim 15, wherein at least one of the titanium sulfide and the transition metal sulfide is formed in-situ.

22. An all-solid-state composite electrode material, comprising:
an active material comprising at least one of a transition metal sulfide, lithium sulfide, and elemental sulfur; and
a solid-state electrolyte and titanium sulfide.

23. The electrode material of claim 22, wherein the transition metal sulfide comprises a phase of iron sulfide comprising at least one of FeS₂, FeS and Fe₇S₈.

24. The electrode material of claim 22, wherein the titanium sulfide includes particles having a diameter of less than 2 microns.

25. The electrode material of claim 22, wherein the titanium sulfide is lithiated.

26. The electrode material of claim 25, wherein the lithiated titanium sulfide is formed in-situ.

27. The electrode material of claim 22, containing about 2 to 40% titanium sulfide by mass.

28. The electrode material of claim 22, wherein at least one of the titanium sulfide and the transition metal sulfide is formed in-situ.
